(19) United States
(12) Patent Application Publication
(10) Pub. No.: US 2016/0192185 A1
(43) Pub. Date: Jun. 30, 2016

(54) Beacon Activated Software

(71) Applicants: Donald Putnam Henry, Menlo Park, CA (US); Charles Marshall, Atherton, CA (US)

(72) Inventors: Donald Putnam Henry, Menlo Park, CA (US); Charles Marshall, Atherton, CA (US)

(73) Assignee: PEERAMYD, LLC, Menlo Park, CA (US)

(21) Appl. No.: 14/843,106

(22) Filed: Sep. 2, 2015

Related U.S. Application Data
(60) Provisional application No. 62/045,371, filed on Sep. 3, 2014.

(51) Int. Cl. H04W 12/02; H04W 40/24

(52) U.S. Cl. CPC H04W 12/02; H04W 40/244

(57) ABSTRACT

Electronic devices which can execute code are increasingly ubiquitous. These devices execute code autonomously, in response to user controls at the device, or in response to code or information received when the device communicates with other entities. Oftentimes, such devices remain in a passive mode, open to receipt of electromagnetic, acoustic or other signals but not actively transmitting signals. Several situations including but not limited to broadcast of urgent and time critical information, activation of privacy controls on a device, or activation of affinity or other marketing software make it desirable to have such devices execute code differently and in some circumstances behave differently upon receipt of a beacon signal. This disclosure describes such processes.

### CROSS REFERENCE TO RELATED APPLICATIONS

The present application relates to and claims priority of U.S. provisional patent application (“Copending Provisional Application”), Ser. No. 62/045,371, entitled “BEACON ACTIVATED SOFTWARE,” filed on Sep. 3, 2014. The disclosure of the Copending Provisional Application is hereby incorporated by reference in its entirety.

### BACKGROUND OF THE INVENTION

1. Field of Invention

The present application relates to the differential execution of code on an electronic device when such a device detects a beacon signal. Such a process allows a device to behave differently based on an external stimulus not resident on the device even when the device is only passively receiving information. Among other uses, differential execution could enable privacy protections limiting the data collection capabilities of a device such as a smart phone in certain places and certain times, could activate an affinity program installed by a user to alert the user to locations nearby, provide discounts or other opportunities at such locations, disable or change features of a device such as preventing a phone from ringing (perhaps putting it in vibrate mode) during a performance (such as opera, symphony, stage, or cinema), change a device from silent mode to deliver urgent information such as a severe weather alert, or merely change settings and preferences when at home or work.

2. Discussion of Related Art

Highly sophisticated electronic devices have become ubiquitous, distributed, and often mobile: smart phones, tablets, laptop and desktop computers, smart electronics built into cars and other consumer items, distributed and connected sensors and switches (i.e. for smart homes) as part of the internet of things, smart meters, etc. For the most part, these devices perform in predetermined ways, react to user input, or respond to commands and signals when a two-way communications path is established between the device and other entities. There may be significant enhancements to functionality when the device reacts differently to an external signal of some sort (described using the term beacon here) which can work when the device is fully functioning but even work when the device is only passively receiving information. As a simple example, a mobile phone may be put into vibrate mode only when a person is at work (based on the WiFi® signal at work) and back into normal ringing mode when home (based on the home WiFi®). A locally broadcast beacon might take phones out of vibrate or silent mode when severe weather is approaching (such as a tornado) or in the case of a national emergency. Beaconing might be used to restrict, change, limit, or alter the data collection capabilities of a device in certain places and/or at certain times. Such functionality might be used to ensure privacy and security in certain sensitive locations from unconsented collection or recording. Similarly, a device user may load software which alerts him to beacons from certain commercial establishments and provide discounts, suggestions, or other benefits for the user.

### SUMMARY OF THE INVENTION

This application discloses a process whereby software is differentially executed by an electronic device based on detection of an external beacon signal. Once the beacon signal is detected by the device, some set of software is executed differently than it would have been in the absence of such detection, causing the device to behave differently in some cases. The response to the beacon signal might directly cause the device to behave differently or cause the device to interact with another source of data or direction. There are a number of reasons why such a configuration may be useful including power conservation, emergency alerts, and activation of privacy protection or affinity marketing software. It could also be used to control a potentially large number of distributed devices (such as may be found in the internet of things).

### BRIEF DESCRIPTION OF THE DRAWINGS

FIG. 1: Beacon controls code execution on device. Beacon signal, when received, causes device to execute different code than when not received.

FIG. 2: Beacon causes device to reference external data source and execute code in accordance with such registry.

FIG. 3: Beacon causes device to in turn direct different execution of code at external location (another physical device or cloud).

FIG. 4: Beacon controls multiple devices within a class with signal

### DETAILED DESCRIPTION OF THE PREFERRED EMBODIMENTS

This application discloses a process whereby software is differentially executed by an electronic device based on detection of an external beacon signal. Such a signal could be electromagnetic, acoustic (inside or outside audible range), or some other form of signal detectable by the electronic device. By beacon, we mean a signal which is external to the device and broadcast to and potentially receivable by all devices in an area rather than directed to a particular device. A beacon requires no communication with, response from, or even awareness of the presence of a device. While the functionality of a beacon is one way (from the broadcast point to the device) and requires no response from the device, it can be part of a two-way signal (i.e., the broadcast address (SSID or Service Set Identifier) of a WiFi® router could be used as a beacon even if the device merely detects rather than connects to that WiFi® network). The beacon signal may or may not be encrypted.

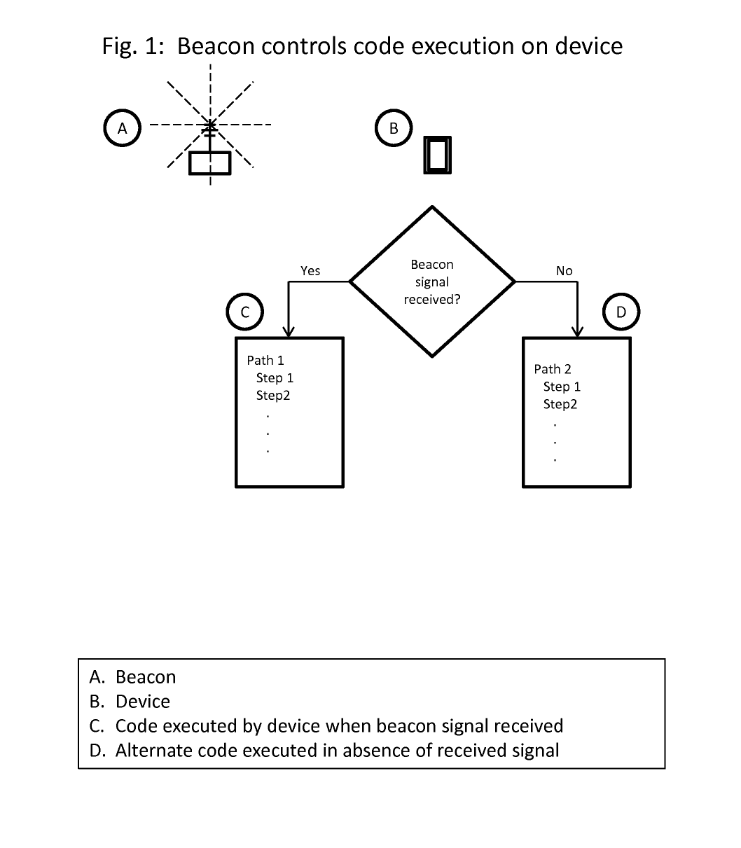

Once the beacon signal is detected by the device, some set of software is executed differently than it would have been in the absence of such detection, causing the device to behave differently in some cases. (See FIG. 1.) The beacon receipt and consequent differential execution could be accomplished at the operating system level, the application programming interface level (API), by an application or program running on the device, through code executed in the cloud in response to signals from the device, or some combination of these methods.

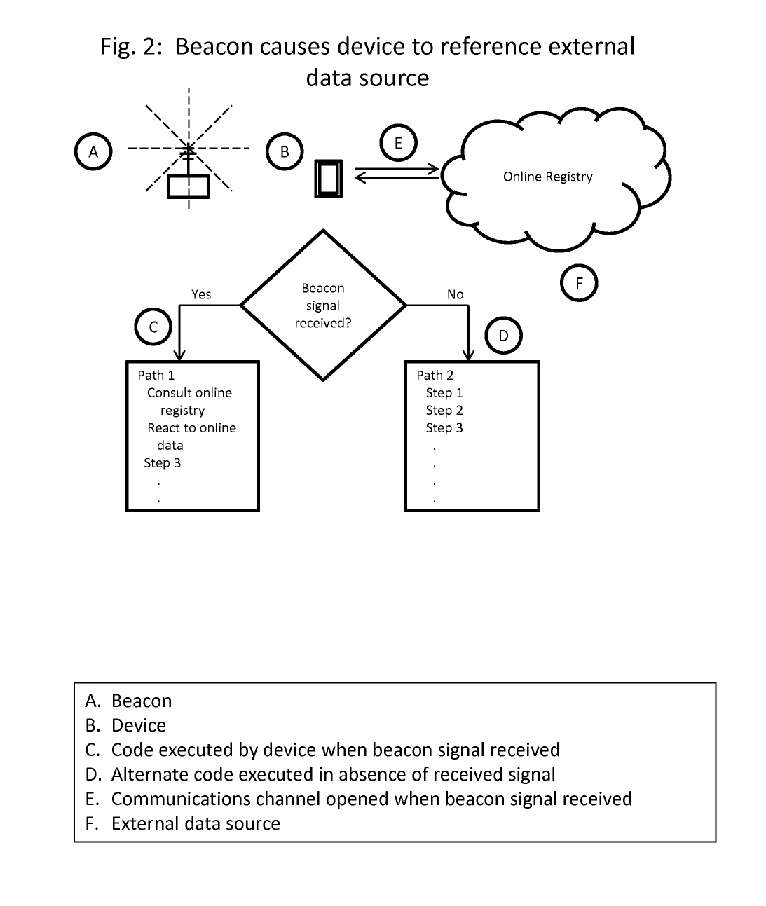

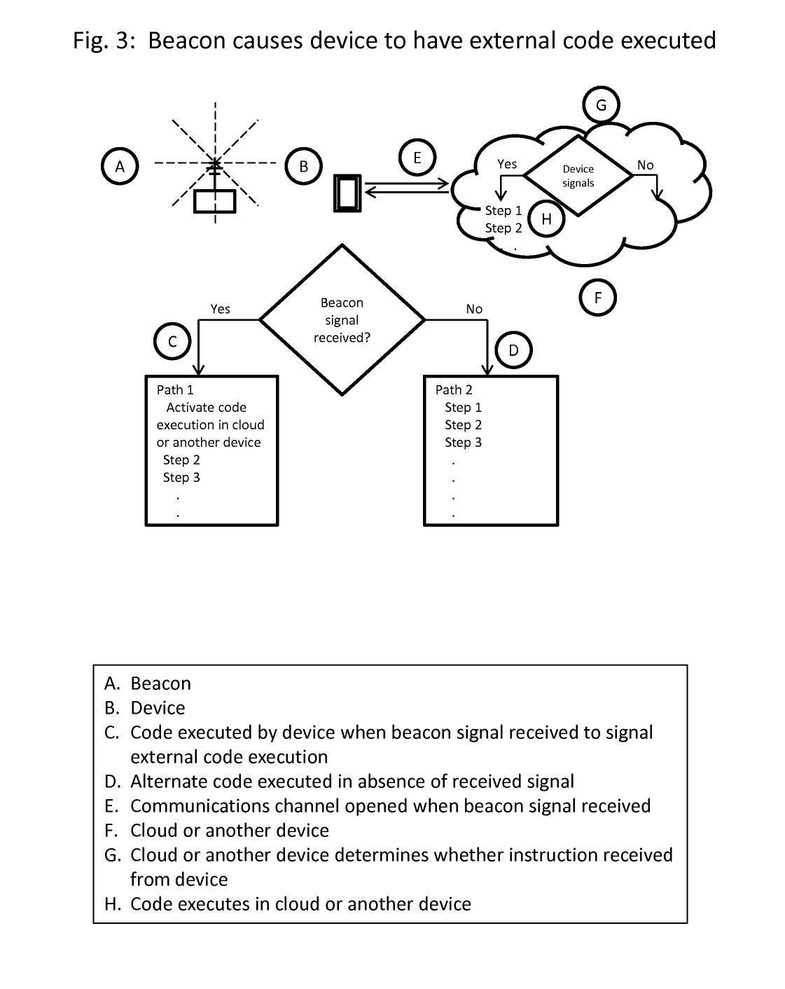

The response to the beacon signal might directly cause the device to behave differently or cause the device to interact with another source of data or direction. In the latter case, it may serve as an alert or “wake up call” to otherwise have the device communicate with an external source of data or instructions which can in turn be processed on or off the device. (See FIGS. 2 and 3.) This configuration allows (but does not require) devices to maintain conditional functionality without allowing the device to remain in a passive, receive only mode.

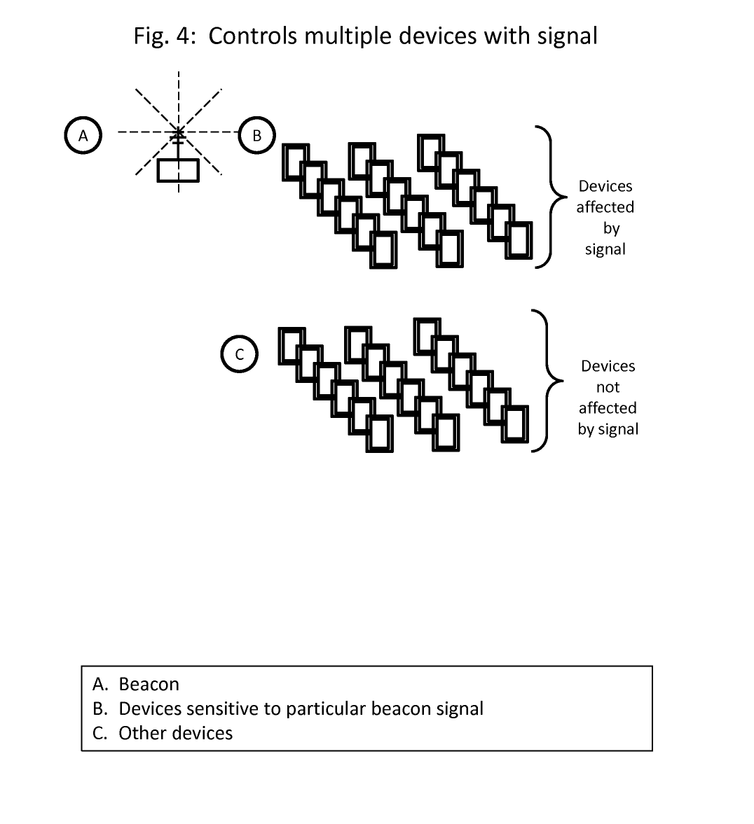

There are a number of reasons why such a configuration may be useful. Devices can conserve power or users can better protect their privacy by keeping devices in passive mode. Geographically-based controls of mobile device collection might be accomplished by activating blocking software whenever the device is turned on. Emergency alerts can reach a larger number of users. It could also be used to control a potentially large number of distributed devices (such as may be found in the internet of things). For example, enabling or disabling all (or some) sensors in a security system. (See FIG. 4.)

The ubiquity of connected devices in the so-called internet of things as well as increased hacking concerns generally raise the possibility of a beacon dependent layer of security for devices. For example, a business might encrypt its data with the decryption program only enabled in the presence of a beacon signal. Similarly, distributed devices in a home or business may receive a beacon signal and only transfer information to another device (such as a laptop or tablet) which is receiving the same beacon signal, in effect foreclosing remote access for some capabilities.

What is claimed is:

1. A method whereby an electromagnetic, acoustic, or other beacon signal, encoded or open, is received by an electronic device causing that device to execute itself or cause to execute elsewhere some code differently than it would in the absence of the beacon signal and, in some cases, behave differently or cause other devices to behave differently because of the differentially executed code.

2. A specific embodiment of claim 1 in which the beacon signal is used to denote geographic areas in which different code execution is important.

3. A specific embodiment of claim 2 in which the differentially executed code activates or alerts the device to activate a program (within the operating system, the application program interface, in an application, or code within the cloud) which limits, alters, controls, or tags with metadata collection capabilities of a mobile or movable device for the purposes of protecting the privacy and security of a location that the device is in or near.

4. A specific embodiment of claim 3 in which controls or restrictions are differentially applied to devices based on payment or other compensation, on the identity of the owner or user of the device, or on the type or capabilities of the device.

5. A specific embodiment of claim 2 in which the differentially executed code activates or alerts the device to activate a executable program (within the operating system, the application program interface, in an application, or code within the cloud) which is linked to a commercial rewards, customer, loyalty, or marketing or promotion program.

6. A specific embodiment of claim 5 in which the executable program, possibly along with other functionality, provides coupons, incentives, or advice to the device user.

7. A specific embodiment of claim 5 in which the executable program, possibly along with other functionality, tags some or all of the data collected in the vicinity of beacon to allow for such data to be later identified.

8. A specific embodiment of claim 7 in which payment, rewards, or other incentives are provided to the users or owners of devices collecting and disseminating data in the vicinity of the beacon.

9. A specific embodiment of claim 1 in which a beacon signal can be used to enable or disable all or a defined subset of devices in an area (such as turning on or off all sensors in a security system).

10. A specific embodiment of claim 1 in which the presence of a signal is used to secure data or validate flows of information.

11. A specific embodiment of claim 11 in which the signal enables a program which decrypts encrypted data.

12. A specific embodiment of claim 10 in which data in distributed devices is allowed by computer code to be sent only to other devices where both devices are receiving the same beacon signal.
